(19) United States
(12) Patent Application Publication
(10) Pub. No.: US 2004/0218521 A1
(43) Pub. Date: Nov. 4, 2004

(54) Method for data communication between a single-carrier system and a multi-carrier system

(76) Inventors: Edgar Bolinth, Monchengladbach (DE); Ralf Kern, Bocholt (DE)

Correspondence Address: BELL, BOYD & LLOYD, LLC, P. O. BOX 1135, CHICAGO, IL, 60690-1135, US

(21) Appl. No.: 10/485,534

(22) PCT Filed: Aug. 1, 2001
(86) PCT No.: PCT/DE01/02926

(51) Int. Cl. H04J 11/00

(52) U.S. Cl. 370/206

(57) ABSTRACT

A method for data communication between a single-carrier system is provided, wherein a received single-carrier signal is spectrally scanned by the multi-carrier system which decides upon received data according thereto and/or simulates a single-carrier signal with its own carriers.

The invention relates to a method and an apparatus for data communication between a single carrier system and a multicarrier system, and also to a transmitter and a receiver for single carrier signals and multicarrier signals.

To transmit message signals using frequency-selective multipath propagation channels, the signals to be transmitted are converted from their normal low-pass frequency to higher frequency ranges by modulation. The relatively high frequency used for transmission is called the carrier frequency or the carrier. If this carrier frequency is sufficiently high, then it is possible to make use of the advantage of transmission by radio in an advantageous manner.

Carrier (frequency) systems, that is to say apparatuses for transmitting signals using the carrier frequency technique, can use a single carrier (frequency) or else a plurality of carrier (frequencies) for transmission. A system which uses just one carrier frequency or one carrier is usually called a single carrier (frequency) system. Systems which use a plurality of carrier frequencies for transmission are also known as multicarrier (frequency) systems.

A typical representative of a multicarrier system is an OFDM system. OFDM stands for orthogonal frequency division multiplexing. This system is particularly well suited to the terrestrial transmission of digital signals at a high level of interference. OFDM systems are used in digital broadcasting, for example.

In addition, OFDM allows the use of the frequency division multiple access method of access (FDMA), which can be used advantageously in mobile radio technology in particular. In the case of FDMA, the available bandwidth of a transmission channel is divided into a plurality of adjacent disjunct constituent frequency channels. The individual constituent frequency channels are then used as individual communication channels for various connections.

In the case of OFDM, on the other hand, data symbols for a communication link are transmitted in parallel, so to speak, using a plurality of such constituent frequency bands. Transmission in an individual constituent frequency band takes place on a narrowband basis. A single constituent frequency band therefore requires relatively little bandwidth for transmission. The low bandwidth of a constituent frequency band means that the altogether frequency-selective transmission channel is split into a plurality of non-frequency-selective AWGN (Additive White Gaussian Noise) constituent transmission channels. This allows receiver-end implementation of an efficient frequency domain equalizer, which usually comprises an FFT (Fast Fourier Transformation) unit and a channel estimation and correction unit. Hence, essentially the parallel transmission of data symbols using a plurality of constituent frequency bands means that a very high transmission quality is still possible even when multipath propagation channels have a high level of interference. In addition, intersymbol interference resulting from echo formation on the transmission channel can be effectively reduced by adding a time prefix to the OFDM useful symbol component.

A drawback of the multicarrier systems known to date, however, is that communication with a single carrier system without further, not inconsiderable additional complexity is neither envisaged nor possible. By way of example, a single carrier system, in which the data to be transmitted are modulated onto a single carrier using frequency shift keying (FSK), cannot communicate with an OFDM system.

It is therefore an object of the present invention to propose a method and an apparatus for data communication between a single carrier system and a multicarrier system. The aim is also to specify a low-complexity transmitter structure and receiver structure for both single carrier signals and multicarrier signals.

This object is achieved by a method for data communication between a single carrier system and a multicarrier system having the features claimed in claim 1, by a corresponding apparatus having the features claimed in claim 10 and also by a transmitter and a receiver for single carrier signals and to a multicarrier signals having the features claimed in claim 14 or 15. Preferred refinements are the subject matter of the dependent claims.

It will be pointed out, in particular, that this transmission and receiver structure is not restricted merely to FSK modulation, but rather can be applied on the whole to the class of digital nonlinear modulation types and analog nonlinear and linear modulation types. Classical analog nonlinear modulation types include FM (frequency modulation) and WM (angle modulation), whose digital derivatives are respectively FSK (Frequency Shift Keying) modulation and CPFSK (Continuous Phase Frequency Shift Keying), which is also called CPM (Continuous Phase Modulation). Although GMSK (Gaussian Minimum Shift Keying) is linear modulation, it can be interpreted as a special case of FSK, which means that the aforementioned transmitter and receiver structure can likewise be applied to GMSK modulated systems such as GSM and DECT. A classical analog modulation form is AM (amplitude modulation), which continues to be widespread in the area of medium wave and long wave broadcasting. In line with the invention, the aforementioned transmitter and receiver structure can likewise be used for AM as well.

One fundamental aspect of the invention is that data communication between a single carrier system and a multicarrier system can be brought about by virtue of the multicarrier system simulating the spectral signal components of the single carrier system. To this end, essentially the multiplicity of carriers in the multicarrier system is used.

The invention thus relates to a method for data communication between a single carrier system and a multicarrier system. At the reception end, the multicarrier system subjects a received single carrier signal to spectral sampling and takes this as a basis for making a decision about received data. At the transmission end, a single carrier signal to be transmitted is simulated by the multicarrier system with its carriers. For a bidirectional mode, the multicarrier system subjects a received single carrier signal to spectral sampling and takes this as a basis for making a decision about received data; in addition, the multicarrier system simulates a single carrier signal which is to be transmitted with its carriers. Whereas, in a multicarrier system, the IFFT (Inverse Fast Fourier Transformation) and/or FFT (Fast Fourier Transformation) algorithm is used for multicarrier modulation and/or multicarrier demodulation, a single carrier system uses IFFT and/or FFT to simulate the spectral signal components of the single carrier useful signal. In principle, this allows bidirectional data communication between the two systems.

Preferably, the center frequency, frequency swing and further relevant system parameters of the single carrier system have been matched to intervals between the carrier frequencies, center frequency and further relevant parameters of the multicarrier system. These system parameters of the single carrier system are also called system-inherent parameters of the system.

A decision is made about received data preferably on the basis of the amplitude and phase of the spectrally sampled single carrier signal. Both amplitude and phase can be evaluated in a relatively simple manner. In addition, they represent reliable criteria for a safe decision about the received data.

In one preferred area of use for the invention, signals are transmitted and/or received by multicarrier systems using orthogonal frequency division multiplexing. OFDM is—as already mentioned at the outset—advantageously applied primarily when transmitting signals using frequency-selective multipath propagation channels. It can advantageously be used not only for digital broadcasting, power line communication and similar transmission methods using OFDM, but also in mobile radio technology.

Finally, in one preferred refinement of the method, the single carrier system modulates signals using frequency shift keying (FSK) . FSK is preferably used in mobile radio technology and in the cordless telephone sector. It is primarily suitable for the transmission of signals using radio channels.

The invention also relates to an apparatus for data communication between a single carrier system and a multicarrier system. In this context, a transmission path contains a magnitude/phase allocator, which, on the basis of magnitude and phase, allocates carriers of a multicarrier signal a single carrier signal which is to be transmitted, and/or a reception path contains a magnitude/phase evaluator, which evaluates the carriers of a received multicarrier signal on the basis of magnitude and phase, and, downstream thereof, a decision maker which makes decisions about received data. Preferably, the transmission path comprises a multicarrier data source and a single carrier data source. The signals from the single carrier data source are supplied via a multiplexer to an IFFT (Inverse Fast Fourier Transformation) unit. Whereas in a multicarrier system the IFFT and/or FFT algorithm is used for multicarrier modulation and/or multicarrier demodulation, a single carrier system uses IFFT and/or FFT to simulate the spectral signal components of the single carrier useful signal. In line with the invention, it is also possible to use IDFT (Inverse Discrete Fourier Transformation) and/or DFT (Discrete Fourier Transformation) instead of IFFT and/or of FFT.

The reception path preferably comprises an FFT (Fast Fourier Transformation) unit, which transforms received signals from the time domain to the frequency domain, a demultiplexer, which multiplexes the received signal transformed by the FFT unit onto carriers, and a single carrier data sink and a, multicarrier data sink. The refinements explained above allow advantageous provision of an apparatus for, in particular, bidirectional data communication between a single carrier system and a multicarrier system.

The invention also comprises a transmitter for single carrier signals and multicarrier signals. This transmitter has a multicarrier data source and a single carrier data source. A single carrier signal generated by the single carrier data source is allocated to carriers of a signal, which has been generated by the multicarrier data source, by a magnitude/phase allocator on the basis of magnitude and phase. A multiplexer multiplexes the signals allocated by the magnitude/phase allocator and the signals from the multicarrier data source onto carriers of the multicarrier signal which is to be transmitted. Finally, the signals multiplexed by the multiplexer are supplied to an IFFT unit which transforms them from the frequency domain to the time domain.

The invention also relates to a receiver for single carrier signals and multicarrier signals which has an FFT unit, inter alia. This FFT unit transforms the received signals from the time domain to the frequency domain. In addition, the receiver has a demultiplexer which multiplexes the received signals transformed by the FFT unit onto carriers of a multicarrier signal. Connected downstream of the demultiplexer is a magnitude/phase evaluator which evaluates supplied signals on the basis of magnitude and phase. Finally, the magnitude/phase evaluator has a decision maker connected downstream of it which makes decisions about received data. The data for which decisions have been made are then supplied to a single carrier data sink. The output signals from the demultiplexer may also be supplied to a multicarrier data sink.

The invention is now explained below using exemplary embodiments in conjunction with the drawings, in which

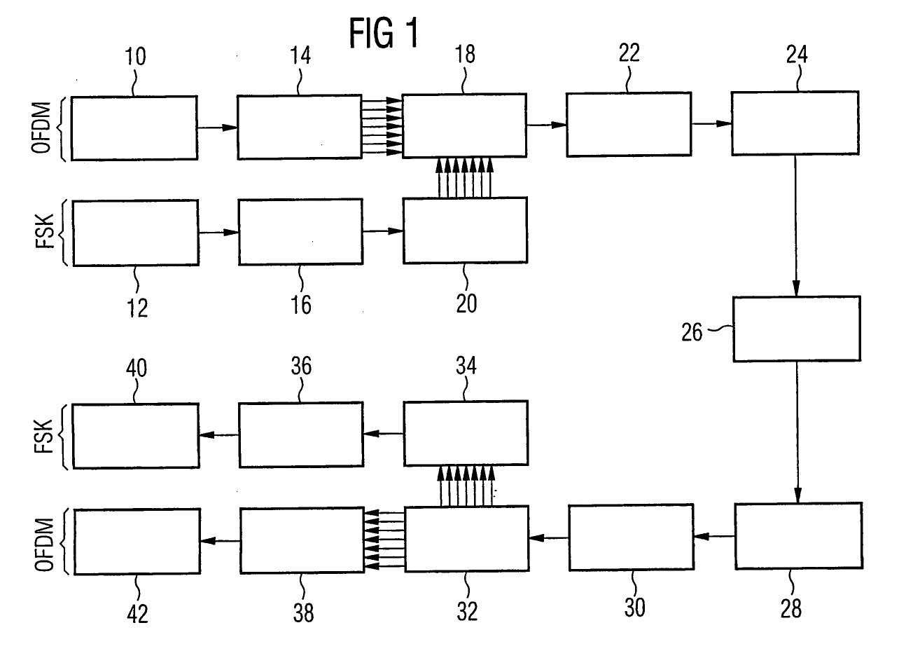

FIG. 1 shows an exemplary embodiment of an apparatus for data communication using multicarrier signals, which apparatus can be used to transmit both single carrier signals and multicarrier signals;

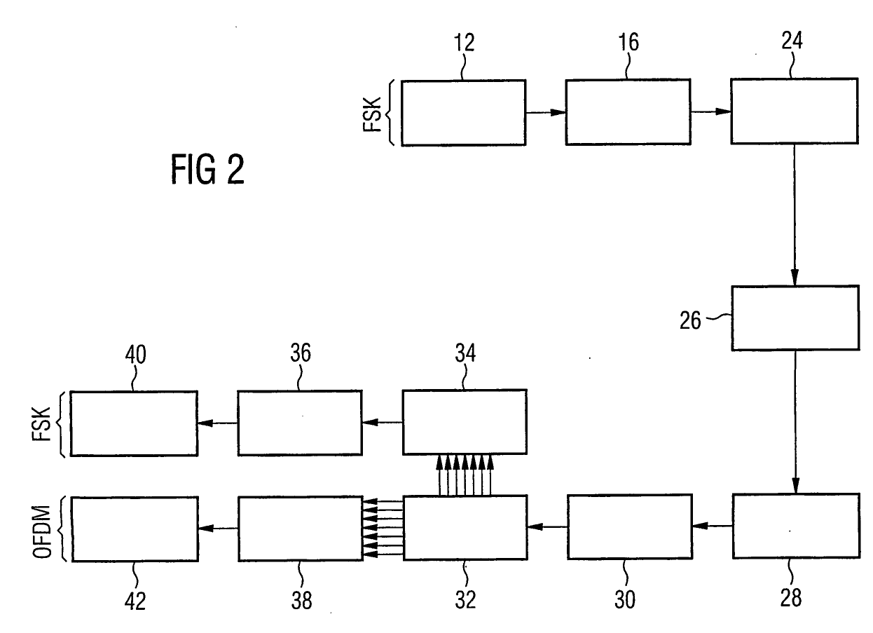

FIG. 2 shows an exemplary embodiment of an apparatus for data communication between a single carrier system and a multicarrier system where the single carrier system is a transmitter and the multicarrier system is a receiver; and

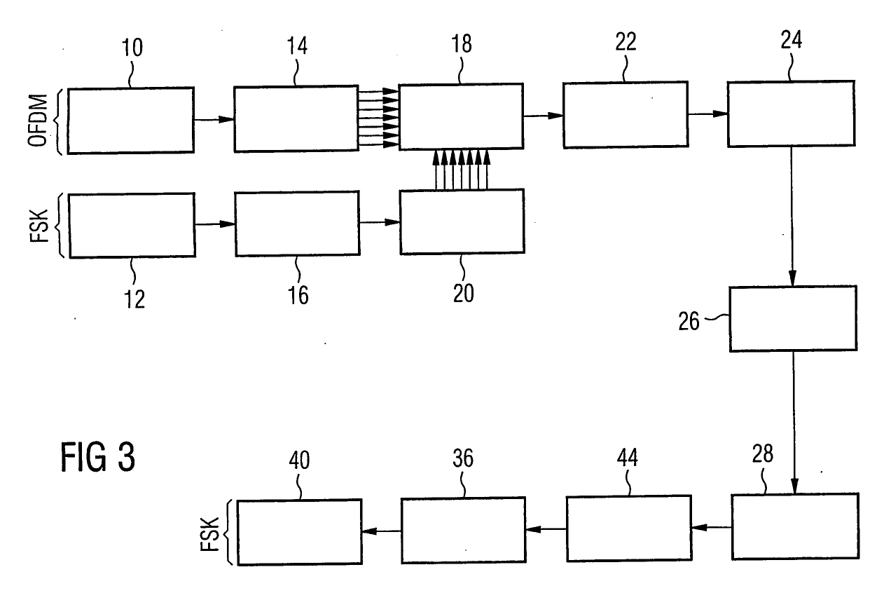

FIG. 3 shows an exemplary embodiment of an apparatus for data communication between a single carrier system and a multicarrier system where the single carrier system is a receiver and the multicarrier system is a transmitter.

The transmission path of the apparatus shown in FIG. 1 contains an OFDM data source 10 as a multicarrier signal source and an FSK data source 12 as a single carrier signal source. In the transmission path, signals are digitally generated and processed essentially in the frequency domain. Prior to transmission, they are transformed to the time domain.

Signals generated by the OFDM data source 10 are converted into a parallel signal using a downstream QAM modulator 13 and a serial/parallel converter 14. To be more precise, the data packets, for example bits or bytes, contained in the serial input signal for the converter 14 are distributed over parallel lines in order to be able to transmit them in parallel using a plurality of carrier frequencies.

The parallel output signals from the converter 14 are supplied to a multiplexer 18 which multiplexes them onto carriers of a multicarrier signal which is to be transmitted. Connected downstream of the multiplexer 18 is an IFFT unit 22 which transforms the supplied signals from the frequency domain to the time domain. These transformed signals are then transmitted using a transmitter 24.

The single carrier signals generated by the FSK data source 12 are modulated onto a single carrier frequency by a frequency domain modulator 17, to be more precise an FSK modulator. The signal generated by the FSK modulator 17 is then supplied to a magnitude/phase allocator 20 which allocates the supplied signal to the individual carriers of the multicarrier signal on the basis of magnitude and phase. The signals allocated in this manner are supplied to the multiplexer 18, which multiplexes them onto the individual carriers.

Signals generated by the reception path in this manner are transmitted using a transmission channel 26 and are received by a receiver 28 in the transmission path. The signals received by the receiver 28 are supplied to an FFT unit 30 which transforms them from the time domain to the frequency domain. The subsequent processing of the signals then takes place essentially digitally in the frequency domain.

Connected downstream of the FFT unit 30 is a demultiplexer 32 which demultiplexes the output signals generated by the FFT unit 30 onto the individual carriers of the received multicarrier signal.

To the output signal from the demultiplexer 32 are firstly supplied to a serial/parallel converter 38 which converts them into a serial data stream and transmits them to an OFDM data sink 42 via a QAM demodulator and decision maker 39. Secondly, the output signals from the demultiplexer 32 are supplied to a magnitude/phase evaluator 34 which evaluates the signals from the individual carriers on the basis of magnitude and phase and transmits the signals evaluated in this manner to a frequency domain demodulator and decision maker 37.

The frequency domain demodulator and decision maker 37 makes the decision about the received data sequence and transmits the data obtained in this manner to an FSK data sink 40.

The apparatus shown in FIG. 1 can thus be used to transmit, particularly to send and receive, single carrier signals modulated with FSK using a multicarrier system. This affords the advantages of multicarrier transmission, such as very low susceptibility to interference, for single carrier signals as well. Although the transmission in the apparatus in FIG. 1 is indicated in one direction only, bidirectional data communication is equally possible in principle.

The apparatus shown in FIG. 2 is a system for unidirectional data communication between a single carrier system and a multicarrier system. In this apparatus, the single carrier system is a transmitter and the multicarrier system is a receiver. Since the apparatus is otherwise the same as the one shown in FIG. 1, apart from the difference that a time domain modulator 16 is used, reference is made to the description of the operation of the individual components in FIG. 1.

Finally, FIG. 3 shows an apparatus which is likewise designed for unidirectional data communication between a single carrier system and a multicarrier system. In this case, the single carrier system is a receiver and the multicarrier system is accordingly a transmitter. For a description of the operation of the individual components, reference is again made to the explanations relating to FIG. 1.

List of reference numerals

10 OFDM data source

12 FSK data source

13 QAM modulator

14 Serial/parallel converter

16 Time domain modulator

17 Frequency domain modulator

18 Multiplexer

20 Magnitude/phase allocator

22 IFFT unit

24 Transmitter

26 Transmission channel

28 Receiver

30 FFT unit

32 Demultiplexer

34 Magnitude/phase evaluator

36 Time domain demodulator and decision maker

37 Frequency domain demodulator and decision maker

38 Parallel/serial converter

39 QAM demodulator and decision maker

40 FSK data sink

42 OFDM data sink

1. A method for data communication between a single carrier system and a multicarrier system, characterized in that the multicarrier system subjects a received single carrier signal to spectral sampling and takes this as a basis for making a decision about received data, or
the multicarrier system simulates a single carrier signal to be transmitted with its carriers, or
the multicarrier system subjects a received single carrier signal to spectral sampling and takes this as a basis for making a decision about received data and the multicarrier system simulates a single carrier signal to be transmitted with its carriers.

2. The method as claimed in claim 1, characterized in that the system-inherent parameters of the single carrier system are matched to intervals between the carrier frequencies, center frequency and further system-inherent parameters of the multicarrier system.

3. The method as claimed in claim 2, characterized in that the system-inherent parameters of the single carrier system describe a nonlinear modulation type based on FSK and/or CPFSK/CPM and/or MSK and/or GMSK and/the frequency modulation and/or angle modulation.

4. The method as claimed in claim 2, characterized in that the system-inherent parameters of the single carrier system describe a linear modulation type such as amplitude modulation and/or ASK/PAM (Amplitude Shift Keying/Pulse Amplitude Modulation).

5. The method as claimed in one of the preceding claims, characterized in that a decision is made about received data on the basis of the amplitude and phase of the spectrally sampled single carrier signal.

6. The method as claimed in one of the preceding claims, characterized in that the multicarrier system sends and/or receives signals using orthogonal frequency division multiplexing.

7. The method as claimed in one of the preceding claims, characterized in that the single carrier system modulates signals using frequency shift keying.

8. The method as claimed in one of the preceding claims, characterized in that the single carrier system modulates signals using continuous phase frequency shift keying.

9. The method as claimed in one of the preceding claims, characterized in that the single carrier system modulates signals using amplitude modulation.

10. The method as claimed in one of the preceding claims, characterized in that the single carrier system modulates signals using (analog) frequency modulation or angle modulation.

11. An apparatus for data communication between a single carrier system and a multicarrier system, characterized in that a transmission path (10, 12, 13, 14, 17, 18, 22, 24) contains a magnitude/phase allocator (20), which, on the basis of magnitude and phase, allocates carriers of a multicarrier signal a single carrier signal which is to be transmitted, and/or a reception path (28, 30, 32, 38, 39, 40, 42) contains a magnitude/phase evaluator (34), which evaluates the carriers of a received multicarrier signal on the basis of magnitude and phase, and, downstream thereof, a frequency domain demodulator and decision maker (37) which makes decisions about received data.

12. The apparatus as claimed in claim 11, characterized in that the transmission path comprises a multicarrier data source and a single carrier data source (10, 12) whose signals are supplied via a multiplexer (18) to an IFFT unit (22) which transforms the supplied signals from the frequency domain to the time domain.

13. The apparatus as claimed in claim 11 or 12, characterized in that the reception path comprises an FFT unit (30), which transforms received signals from the time domain to the frequency domain, a demultiplexer (32), which multiplexes the received signal transformed by the FFT unit (30) onto carriers, and a single carrier data sink and a multicarrier data sink (40, 42).

14. A transmitter for single carrier signals and multicarrier signals, which has
a multicarrier data source and a single carrier data source (10, 12),
a magnitude/phase allocator (20), which allocates carriers of a multicarrier signal a single carrier signal from the single carrier data source (12) on the basis of magnitude and phase,
a multiplexer (18) which multiplexes the signals allocated by the magnitude/phase allocator (20) and the signals from the multicarrier source (10) onto carriers of the multicarrier signal which is to be transmitted, and
an IFFT unit (22) which transforms signals supplied by the multiplexer (18) from the frequency domain to the time domain.

15. A receiver for single carrier signals and multicarrier signals, which has
an FFT unit (30) which transforms received signals from the time domain to the frequency domain,
a demultiplexer (32) which multiplexes the received signal transformed by the FFT unit (30) onto carriers of a multicarrier signal,
a magnitude/phase evaluator (34) which evaluates the signals supplied by the demultiplexer (32) on the basis of magnitude and phase,
a frequency domain demodulator and decision maker (37) which is connected downstream of the magnitude/phase evaluator (34) and makes decisions about received data, and
a single data carrier sink and a multicarrier data sink (40, 42).
